(19) United States
(12) Patent Application Publication
(10) Pub. No.: US 2016/0183722 A1
(43) Pub. Date: Jun. 30, 2016

(54) GRILLING APPARATUS

(71) Applicant: BRAND DEVELOPERS AUST PTY LTD, Port Melbourne (AU)

(72) Inventor: James Fisher, Auckland (NZ)

(21) Appl. No.: 14/909,134

(22) PCT Filed: Aug. 28, 2014
(86) PCT No.: PCT/AU2014/000852

§ 371 Date: Jan. 31, 2016

(30) Foreign Application Priority Data
Aug. 29, 2013 (AU) 2013101148
Feb. 26, 2014 (AU) 2014900620
Apr. 9, 2014 (AU) 2014100346

(51) Int. Cl. A47J 37/07

(52) U.S. Cl. CPC A47J 37/0754; A47J 37/0704; A47J 37/0763; A47J 37/0786

(57) ABSTRACT

A grilling apparatus (10) comprises a base (40) having one or more handles (44) recessed into the base. At least one of the handles (44) comprises therein one or more air inlets (46) to allow air to flow into the base. The grilling apparatus (10) also comprises a grilling surface (70) that in use of the apparatus is located above the base (40). A heat source is, in use of the apparatus, located above the base (40) and under the grilling surface (70). The grilling apparatus further comprises an air motive mechanism (52) for causing air to pass through the one or more air inlets 46 and then to the heat source (12).

### TECHNICAL FIELD

A grilling apparatus is disclosed that can be fabricated to be portable. The apparatus can, for example, take the form of a portable barbeque. The apparatus may also have a compact form.

### BACKGROUND ART

DE 20304173, WO 2006/053693 and JP 07-171058 each disclose a portable barbeque in which charcoal grilling can be achieved whilst providing for charcoal containment.

The above references to the background art do not constitute an admission that the art forms a part of the common general knowledge of a person of ordinary skill in the art. The above references are also not intended to limit the application of the apparatus as disclosed herein.

### SUMMARY OF THE DISCLOSURE

Disclosed herein is a grilling apparatus. The apparatus can be fabricated to take the form of a portable barbeque and may, for example, have a compact form (e.g. to be easily lifted, transported and stored when not in use).

The apparatus can comprise a grilling surface (e.g. a grate, griddle, plate, etc). The grilling surface may conveniently be located at an uppermost part of the apparatus in use. The grilling surface may be detachable. When the grilling surface takes the form of a grate, the grate may comprise a plate arranged centrally therewithin. Such a plate can allow for the frying of food thereon, and can also help to support e.g. containers and like implements placed on the grilling apparatus in use.

The apparatus can also comprise a heat source that in use is located within the apparatus under the grilling surface. The plate of the grilling surface may generally overlie the heat source (i.e. for receipt of and direct on-transmission of heat from the heat source).

A side wall of the heat source can radiate and release heat and heated gases for the grilling of food, etc. The side wall can e.g. be perforated or be otherwise transmissive to heat release and gas flow. The heat source may, for example, radiate and release heat and heated gases in a first direction. The heat source can, for example, be configured to house a solid fuel (e.g. a carbon-based fuel such as charcoal, wood, coal or other combustible solid matter—e.g. grain-derived pellets, etc). However, the apparatus may be reconfigured for a liquid or gaseous fuel.

The apparatus can further comprise an air motive mechanism for supplying air to the heat source in a second direction. The second direction of the air can be generally perpendicular to the first direction of the released heat and heated gases. This change of gas flow direction can result in the air being fully dispersed through e.g. the solid fuel housed in the heat source, i.e. before heat and heated combustion gases are released from the heat source.

The air motive mechanism may take the form of a fan, impeller or pump, although e.g. a fan for simplicity. Conveniently, though not necessarily, the air motive mechanism can be located within the apparatus, so that the apparatus can be provided as a self-contained unit.

The apparatus can additionally comprise a base that can be configured to enable the grilling apparatus to sit stably upon a surface (e.g. table, bench, bench-top, etc). The heat source can, for example, be located above the base and under the grilling surface. The air motive mechanism can be located e.g. centrally within the base.

The base can comprise one or more handles recessed into the base. At least one of the handles can comprise therein one or more air inlets to allow air to flow into the base. In this way the air inlets can be disguised for aesthetic purposes, but this location can also ensure that the handles remain cool to the touch in use of the grilling apparatus. The air motive mechanism can cause air to pass through the one or more air inlets and then to the heat source. For example, a pressurised supply of air to the e.g. solid fuel can facilitate combustion, and the control of such air supply (e.g. by regulating the air motive mechanism) can enable the control of fuel combustion (and thereby provide heat and temperature control).

The base may comprise at least two opposing handles recessed thereinto. In this embodiment each one of the handles may comprise multiple air inlets provided therein to allow maximum air flow into the base, from multiple entry points.

In one embodiment a retention rail (to retain food, pots, implements, etc) can be provided to extend around a perimeter of the grilling surface, e.g. at an elevated location. The rail may be connected to the grilling surface and may comprise a deformation therein to enable a suitable barbecue tool to be supported thereat (e.g. to be hung from the rail at the location of the deformation).

In one embodiment a chamber can house the air motive mechanism therewithin. For example, when the air motive mechanism takes the form of a fan, impeller or pump it can be located within the chamber, optionally together with a motor for the fan, impeller or pump. The chamber can be centrally located within the base, so that the apparatus can be provided as a self-contained, compact unit.

The chamber can comprise an air entrance that is arranged to allow air to pass from within the base and into the chamber (i.e. the air can be drawn into the chamber by the fan, impeller or pump). The chamber can also comprise an air outlet that is arranged to allow air to pass from the chamber to the heat source (i.e. the air can be expelled from the chamber by the fan, impeller or pump). In use, air that passes through the one or more air inlets can be drawn from within base via the air entrance and into the chamber, and can then be expelled via the air outlet to the heat source.

Further, the air can be drawn into the air entrance in one direction, and expelled into the air outlet to the heat source in another direction that is generally perpendicular to said one direction. This can impart swirl and turbulence to the airflow to help it disperse throughout the fuel held in the heat source.

In addition, the airflow rate through the fan, impeller or pump may be variably controlled to thereby control the flow rate of air to the heat source. For example, a motor for the fan, impeller or pump may be of variable speed, whereby the flow of air fed to the heat source can be varied (e.g. to facilitate fuel burn and thereby temperature of the grilling apparatus).

The fan, impeller or pump may be battery powered. In this embodiment, a battery recess may be accessible from an underside of the apparatus (e.g. accessed via a door in the base to enable battery interchange). Alternatively, the battery recess may hold rechargeable batteries, which can be recharged by a suitable plug-in point.

In one embodiment the heat source may take the form of a container that is arranged to contain therein the fuel. A side wall of the container may comprise a cylinder of mesh that is configured to contain therein a solid fuel and its residue in lump, granular or particulate form, but to allow hot combustion gases and radiant heat to pass from within the container, through the mesh, and up to the overlying grilling surface.

The container may also comprise a container base for receiving thereat the side wall. In this regard, the container side wall and the container base may be removable from the apparatus and may also be separable (e.g. the cylinder of mesh can be removably located at the container base). This can allow for easy emptying of ash and/or easy cleaning of the grilling apparatus. The container base may be further arranged to receive therethrough the flow of air from the air motive mechanism (e.g. via an air supply conduit that extends from the chamber air outlet and through an opening of the container base).

The container may also comprise a lid for closing over an in-use upper opening of the container. In accordance with the present disclosure the lid can comprise multiple apertures therein to enable the release of heat from within the heat source in use to e.g. an underside of the grilling surface (e.g. to the plate of the grilling surface that overlies the lid). This upward release of heat from within the heat source can ensure that a substantially uniform heat distribution is achieved across the entire surface of the grilling surface.

When the grilling apparatus is assembled, a central part (e.g. the plate) of the grilling surface can engage with and hold the lid against the container wall, to in turn hold the container wall against the container base (i.e. to contain therein the fuel and its residue).

In one embodiment a perforated or apertured false base may be arranged at the side wall and within the container. The false base may be in spaced relation above the container base and can be configured such that the fuel is able to be located on the false base in use. The false base can be provided with a series of holes, apertures or perforations therethrough which can allow for an even, distributed flow of air to the fuel within the container, such air passing from e.g. the supply conduit that extends from the chamber air outlet and through the container base opening.

The space between the false base and the container base may also accommodate an ignition-type material (e.g. paraffin, etc). This means that the ignition-type material can be located directly under a main chamber of the heat source (i.e. in the space between the false and container bases). The ignition-type material may be pre-ignited (e.g. lit) which can then cause the main fuel of the heat source to become ignited.

The apparatus can further comprise a reflector that surrounds and supports the heat source therewithin. The reflector may have a parabolic profile, and may have a polished heat/light reflecting inner surface (i.e. the in-use upside of the reflector wall). The reflector can accordingly reflect radiation, heat and heated gases emitted by the heat source to the grilling surface. This direction of reflection can be generally perpendicular to the first direction and generally parallel to the second direction.

The reflector may take the form of a bowl, and may be configured such that the base of the heat source sits centrally within the bowl in use.

The reflector may further comprise an annular depression that defines a well that surrounds a central part of the bowl, with a side wall of the reflector bowl extending from the well, and up towards the grilling surface. The well can hold e.g. a liquid that is able to be vaporized and/or a solid which can sublimate, during operation of the grilling apparatus. For example, the liquid may comprise a water-based solution (e.g. marinade, juice, jus, etc) that releases aromatic compounds to flavour a foodstuff that is being grilled on the apparatus. The solid may comprise a substance that is able to sublimate to (form a) smoke to flavour the foodstuff being grilled (e.g. hickory, wood chips, etc).

A central part of the reflector can define a base plate for the heat source (i.e. the heat source can sit and be located centrally on the base plate). The base plate can be raised in relation to the surrounding well. The air supply conduit can be arranged to extend through an opening of the base plate to the heat source. When the apparatus is assembled, the grilling surface can sandwich the heat source and lid between it and the base plate to contain the fuel and its residue therewithin.

The apparatus can further comprise a housing for mounting on the base in use (e.g. the housing may locate on an inwardly protruding peripheral lip that extends around an upper opening of the base). A housing floor may be provided that can be arranged to close an open upper end of the base when mounted thereto.

The housing can be configured to support the grilling surface at an in-use upper end thereof, for example, the housing may comprise an inwardly turned-over peripheral lip that e.g. the grilling surface and e.g. the reflector can locate and rest on. The housing can support the heat source therewithin and, when present, the reflector such that both are located under the grilling surface in use. In this regard, the grilling surface may be releasably secured to the housing (e.g. via spring-loaded clips/clamps). This releasable securing may in turn secure the heat source and reflector within the housing, so that the apparatus can be self-contained and be highly portable.

A side wall of the housing may comprise apertures therein (e.g. a series of elongate slots therethrough) to release hot air from within the housing in use.

### BRIEF DESCRIPTION OF THE DRAWINGS

Notwithstanding any other forms which may fall within the scope of the grilling apparatus as set forth in the Summary, further embodiments of the apparatus will now be provided in the following description, which is given by way of example only and with reference to the accompanying drawings in which:

FIG. 1 shows a perspective view of an assembled grilling apparatus according to an embodiment of the present disclosure;

FIG. 2 shows an exploded perspective view of the grilling apparatus embodiment of FIG. 1;

FIGS. 3 and 4 show two alternative cross-sectional views taken through the grilling apparatus embodiment of FIG. 1;

FIGS. 5A to 5D respectively show plan, front, side and partly-sectioned views of the grilling apparatus embodiment of FIG. 1;

FIGS. 6A to 6D respectively show plan, front, underside plan and sectional views of a base for the grilling apparatus embodiment of FIG. 1;

FIGS. 7A to 7C respectively show plan, front and sectional views of a lid for the grilling apparatus embodiment of FIG. 1;

FIGS. 8A to 8C respectively show plan, side and sectional views of a housing for the grilling apparatus embodiment of FIG. 1;

FIGS. 9A and 9B respectively show plan and side views of an ember pot (mesh) side wall for the grilling apparatus embodiment of FIG. 1;

FIGS. 10A to 10C respectively show plan, side and sectional views of an ember pot (false) base for the grilling apparatus embodiment of FIG. 1;

FIGS. 11A and 11B respectively show plan and side section views of an ember pot ignition base tray for the grilling apparatus embodiment of FIG. 1;

FIGS. 12A to 12C respectively show plan, side and sectional views of a reflector bowl for the grilling apparatus embodiment of FIG. 1;

FIGS. 13A to 13C respectively show plan, side and sectional views of a grill surface for the grilling apparatus embodiment of FIG. 1; and

FIGS. 14A to 14D respectively show plan, end, front and perspective views of a fan chamber for the grilling apparatus embodiment of FIG. 1.

### DETAILED DESCRIPTION OF SPECIFIC EMBODIMENTS

Referring to the drawings, a grilling apparatus is shown in the form of a portable barbeque 10. A heat source in the form of an ember pot 12 is mounted within the barbeque 10. The ember pot 12 is configured to house a solid fuel (e.g. a carbon-based fuel such as charcoal, wood, coal or other combustible solid matter—e.g. grain-derived pellets, etc). However, it should be understood that the barbeque 10 can be reconfigured for a liquid or gaseous fuel.

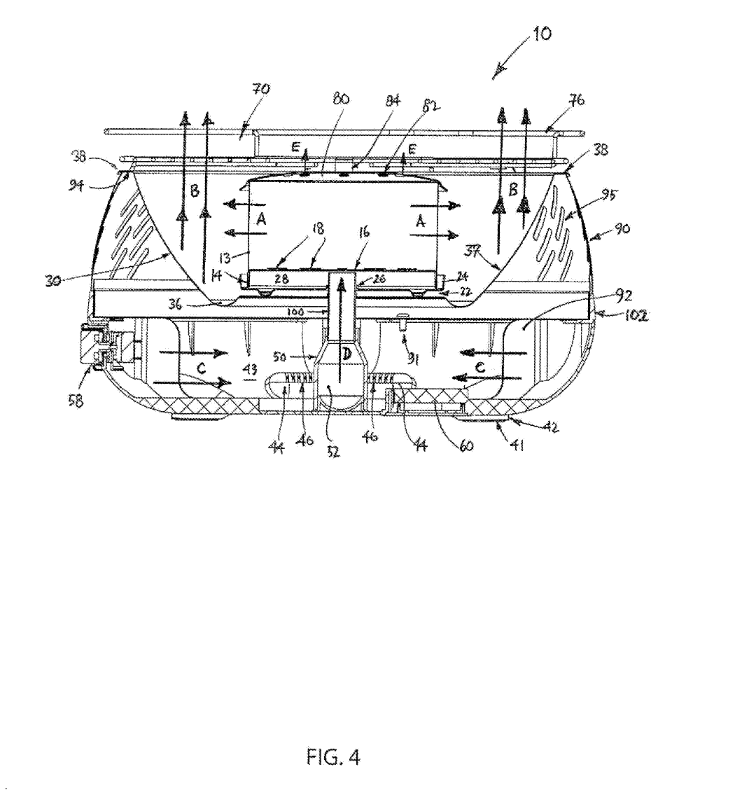

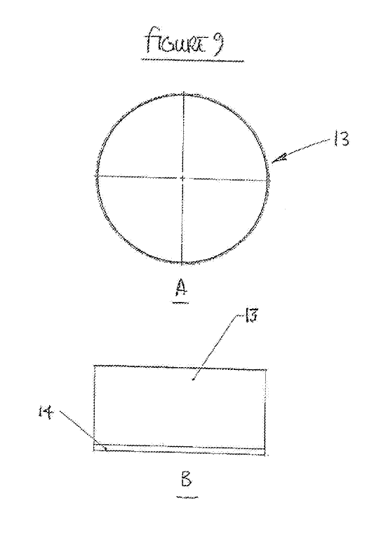

The ember pot 12 comprises a cylindrical mesh wall 13 (shown in detail in FIG. 9); typically formed of a relatively medium-coarse woven metal (e.g. stainless steel) mesh. The mesh is reinforced with a ring 14 around its lower perimeter. A mesh is selected that enables hot combustion (i.e. cooking) gases and radiant heat to be released from within the ember pot 12 whilst, at the same time, containing the solid fuel and its combustion residues (e.g. ash, etc) therewithin, until subsequent disposal after operation of the barbecue. Generally the hot combustion gases and radiant heat flow radially outwards from the ember pot 12 in the direction of arrows A (FIG. 4).

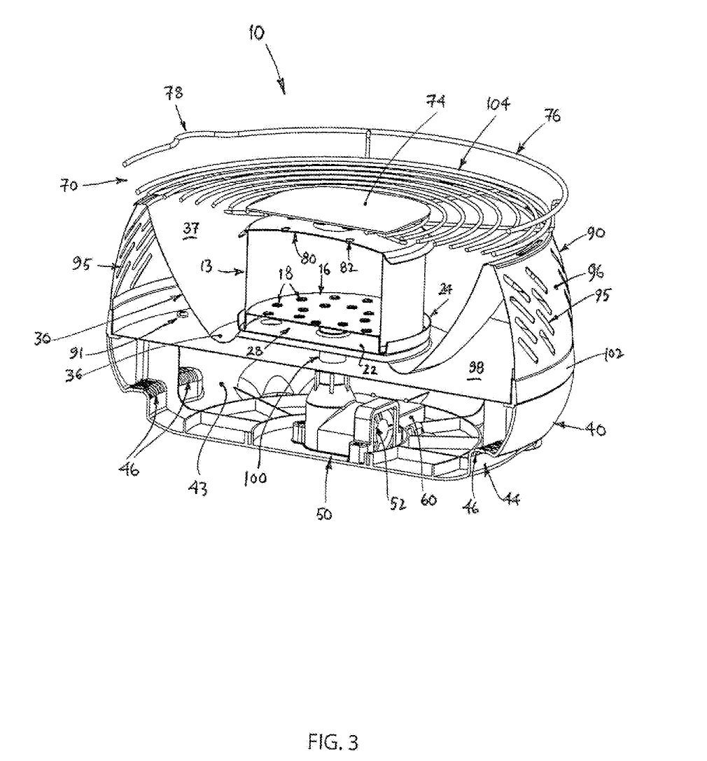

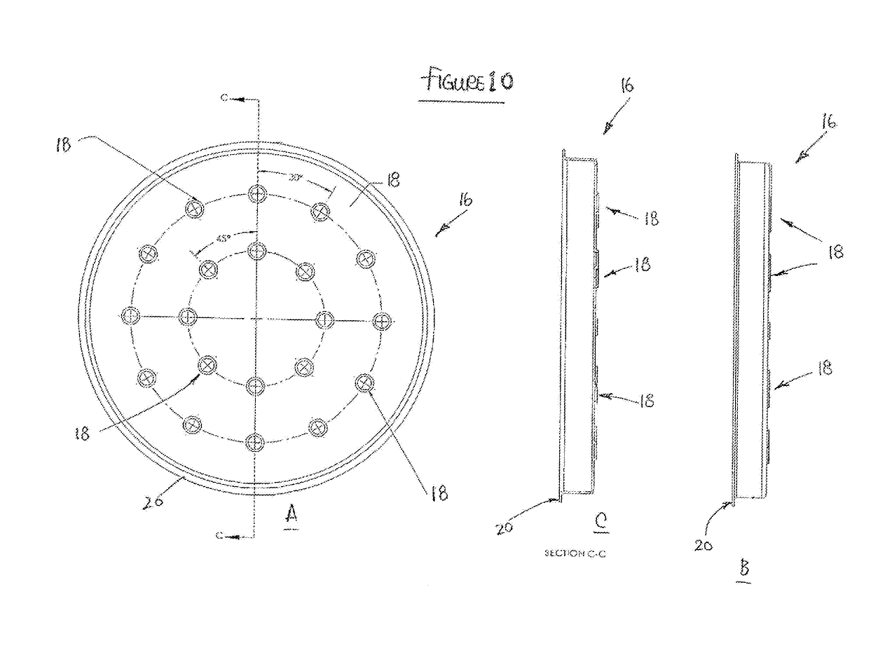

An ember pot base 16 (best shown in FIG. 10) can be located (e.g. secured such as by spot welding) within the mesh wall 13 to define a support surface for the solid fuel located in the ember pot 12 in use. When the base 16 is located within the mesh wall 13 (see FIGS. 3, 4 & 5D), the base defines a type of false (i.e. spaced) base within the ember pot. This spaces the fuel from the bottom of the ember pot 12 to enable maximum and even air supply thereto. Usually the base 16 and mesh wall 13 are secured together to define the ember pot 12 which can be lifted out the barbeque 10 to empty spent fuel and for cleaning. However, in a variation, the base 16 and mesh wall 13 may be separable.

To facilitate air supply into the ember pot 12, the ember pot base 16 is provided therein with two series (located on respective concentric circles) of typically upwardly punched, evenly spaced and discrete holes 18, that enable the air to be evenly fed in use to the fuel located within the ember pot 12 on the base 16. The ember pot base 16 also has an outwardly flared, lower peripheral lip 20 formed thereon, upon which the ring 14 of the mesh wall 13 sits (which ring can also be e.g. spot welded to the lip) once the base 16 has been inserted within the mesh 13.

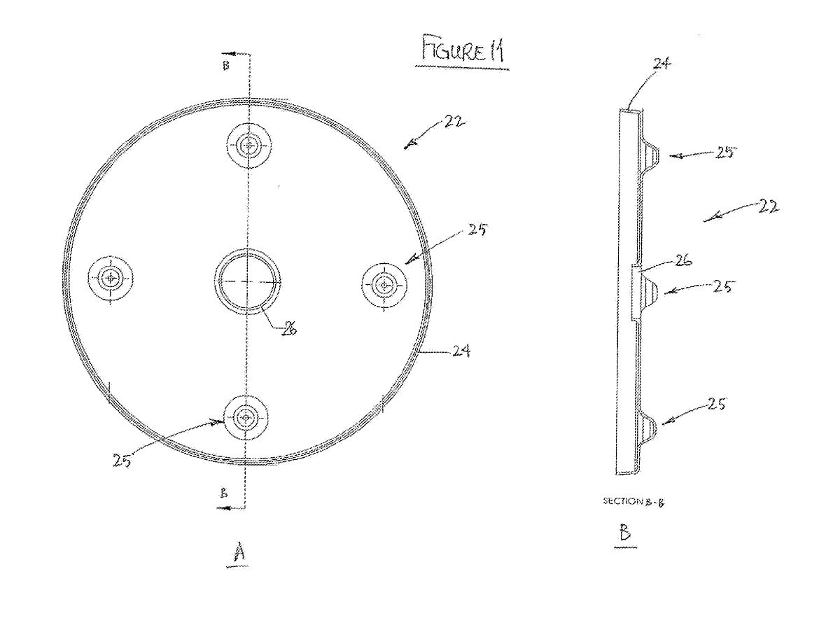

The ember pot 12, comprising mesh 13 and base 16, also sits on an ignition base tray 22 (shown in detail in FIG. 11) when the barbeque 10 is assembled (FIGS. 3, 4 & 5D). The ignition base tray 22 comprises an upturned outer wall 24 to define the tray. When the barbeque 10 is assembled, the outer wall 24 of the ignition base tray 22 provides peripheral support against lateral movement of the ember pot base peripheral lip 20, functioning to centre and support the ember pot 12 therein.

The ignition base tray 22 also comprises four discrete, evenly spaced support feet 25 formed therein. These can sit on a platform 34 of a heat reflector bowl 30 (described in detail below). In addition, a central rimmed opening 26 is defined in the ignition base tray 22 to receive therethrough and support thereat an upper end of an air supply conduit 100 (described in detail below). The conduit 100 provides airflow into a plenum space 28 that is defined between the ember pot base 16 and ignition base tray 22 when assembled. This plenum enables air distribution through the holes 18 and evenly into the ember pot 12 in use.

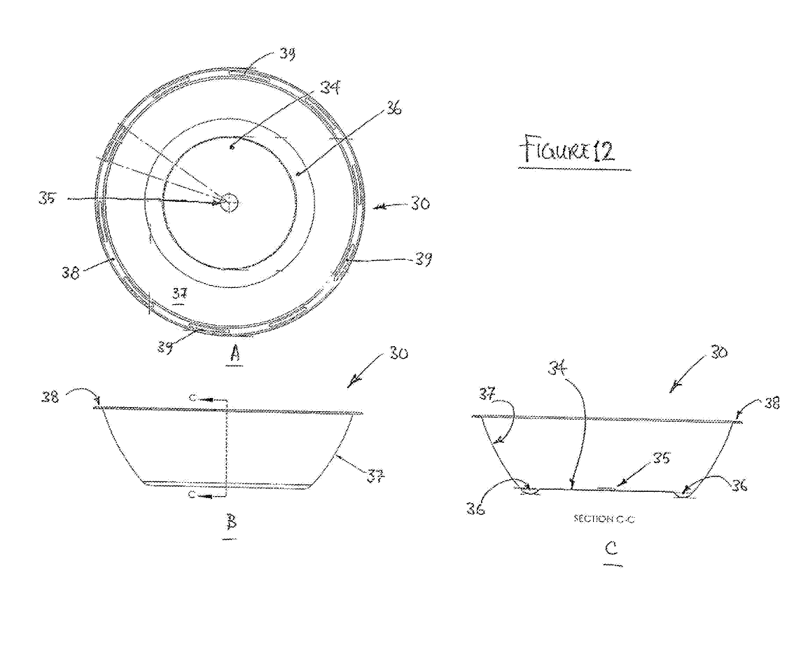

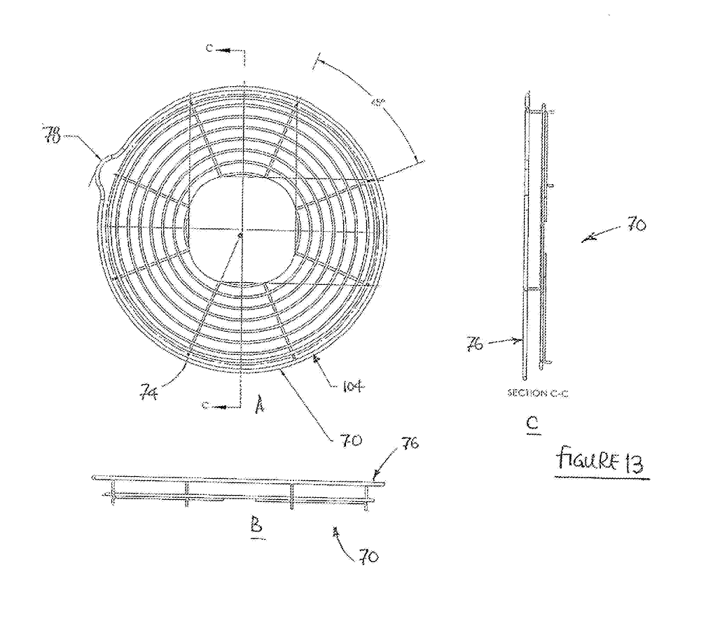

The barbeque 10 additionally comprises a reflector in the form of a heat reflector bowl (shown in detail in FIG. 12) which is arranged to surround and support therewithin the ember pot 12. In this regard, the feet 25 of the ignition base tray 22 sit on a slightly raised central platform 34 of the reflector bowl 30. Again, a rimmed central opening 35 is defined in the platform 34 to receive therethrough the aforementioned air supply conduit 100 (described in greater detail below).

The reflector bowl 30 is also configured to define an annular well 36 that surrounds the platform 34. The well 36 is able to hold a liquid that can vaporize, or can hold a solid that can sublimate, into hot combustion gas flow (arrows B in FIG. 4) during operation of the barbeque 10. For example, the liquid can be a water-based solution (e.g. a marinade, juice, jus, etc) that releases aromatic compounds to flavour a foodstuff that is being grilled on the barbeque 10. The solid may comprise a substance that is able to sublimate to form a smoke that flavours the foodstuff being grilled (e.g. hickory, wood-chip, charcoal, etc). The well 36 may also collect fat and drippings, which can be cleaned out of the well when the reflector bowl 30 is removed from the barbeque after use.

The interior, generally parabolic surface 37 of the reflector bowl 30 is coated and/or polished so as to promote the reflection of heat and radiation, and the flow of combustion (i.e. cooking) gases emitted by the ember pot 12 up towards a grilling surface of the barbeque 10 (see enlarged flow arrows B in FIG. 4). The bowl shape is such as to enhance the redirection of the reflected heat and gases. It will be seen in FIG. 4 that the redirection B is generally perpendicular to the flow direction A.

The upper rim of the reflector bowl 30 has a flat, outwardly projecting peripheral lip 38 defined thereat, which is able to locate on an upper rim of a housing 90 of the barbecue (described in detail below). As also shown in FIG. 12A, a series of air release slots 39 are formed in the lip 38 to facilitate the release of stagnant hot air from an upper region of the barbecue (housing 90) interior in use.

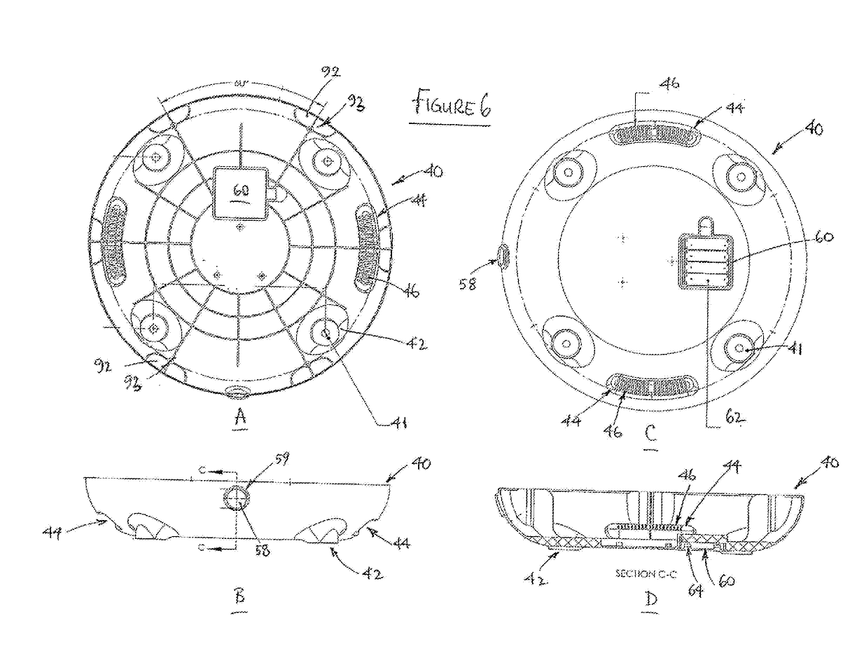

The barbeque 10 comprises a hollow base 40 (best shown in FIG. 6) that is configured to enable the grilling apparatus to sit stably upon a surface (e.g. table, bench, bench-top, etc). In this regard, the base 40 comprises four, evenly spaced feet 42 formed (e.g. moulded integrally) therein that sit stably on rubber feet 41, and that support an underside of the base in a spaced manner above the table, bench, bench-top, etc. The base 40 further defines a hollow interior space 43 to facilitate barbecue airflow.

The base 40 has two opposed recessed handles 44 formed therein. Each of the handles 44 has multiple air inlets therethrough in the form of a series of adjacent elongate slots 46 that are configured to allow atmospheric air to flow into the hollow interior space 43 from the surrounds. The location and orientation of the slots 46 is such that their presence is disguised for aesthetic purposes. However, their location also allows maximum airflow into the base 40 from multiple entry points, and also ensures that the handles 44 remain cool to the touch in use of the barbecue 10 (i.e. whereby a lit barbecue can be picked up, carried and moved).

As illustrated in FIG. 4, room temperature (e.g. cool) air is drawn through the air inlet slots 46 of the handles 44 and across the interior space 43 in the direction of arrows C. The air is then impelled upwardly by a fan 52 (described in greater detail below) in the direction of arrow D, into the ember pot 12. The airflow direction D is perpendicular to the combustion gas flow direction A. This change of direction ensures maximum turbulence and exposure of e.g. solid fuel to airflow within the ember pot 12, enhancing combustion efficiency.

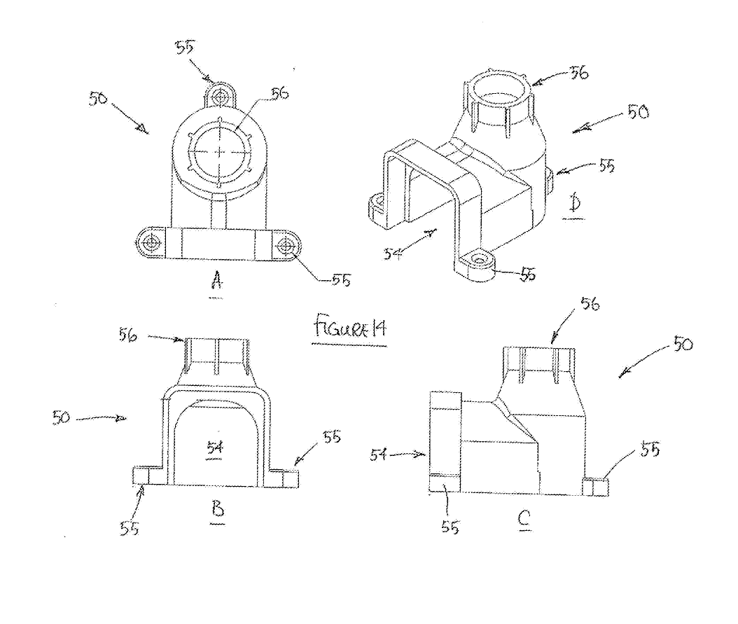

The barbeque 10 comprises an air motive mechanism housed in an air chamber 50 (shown in detail in FIG. 14). An air motive mechanism in the form of a fan 52 is located within the chamber 50. The fan 52 is driven by a motor 53 and draws air into the hollow interior 43 of the base 40 via the slots 46 (arrows C). The fan 52 then expels this air to the ember pot 12 via the air conduit 100 (arrow D). The pressurised supply of air to the fuel disposed in the ember pot 12 also helps to facilitate combustion, with the control of such air supply (flow) enabling combustion (heat and temperature) control.

The chamber 50 is mounted centrally within the base 40 via releasable fasteners (e.g. screws) 51 that extend through mounts 55 (see also FIGS. 3 and 4). The chamber 50 comprises an air entrance passage 54 that is open at one end to allow air to be drawn from within the base hollow interior 43 and into the chamber 50. The chamber 50 also comprises an air outlet passage 56 that is arranged to direct air that is expelled by the fan 52 from within the chamber up to the ember pot 12 via the air conduit 100.

The airflow direction (arrow C) into the entrance passage 54 is generally perpendicular to the airflow direction into the conduit 100 (arrow D). The central location of the chamber 50 within the base 40 and hollow interior 43 ensures that relatively cool air passes through the base, enabling its handling and portability in use, this air then being directed into to the fuel in the ember pot 12.

Thus, a column of air passes centrally up into the plenum space 28 located between the ember pot base 16 and ignition base tray 22. The plenum then distributes the air through the holes 18 and evenly into the ember pot 12 in use. Thus, air can flow over and within e.g. solid fuel located within the ember pot 12 such that the air is fully dispersed throughout the fuel, thereby increasing the combustion and efficiency of the barbeque 10.

The hot combustion gases released from the ember pot 12 in the direction A are caused by the parabolic surface 37 of the reflector bowl 30 to flow up towards the grilling surface of the barbeque 10 in the direction B, which is generally parallel to the airflow direction into the conduit 100 (direction D). Thus, air and combustion gases tend to flow up as well radially out in the barbecue to provide efficient and effective on-transfer of the radiant heat and heat in the gases.

In general, the design and configuration of the barbecue 10 is such that a lower part of the barbecue generally stays cool to the touch, whereas an upper part of the barbecue remains hot for cooking. This again enhances the portability and ease of use of the barbecue 10.

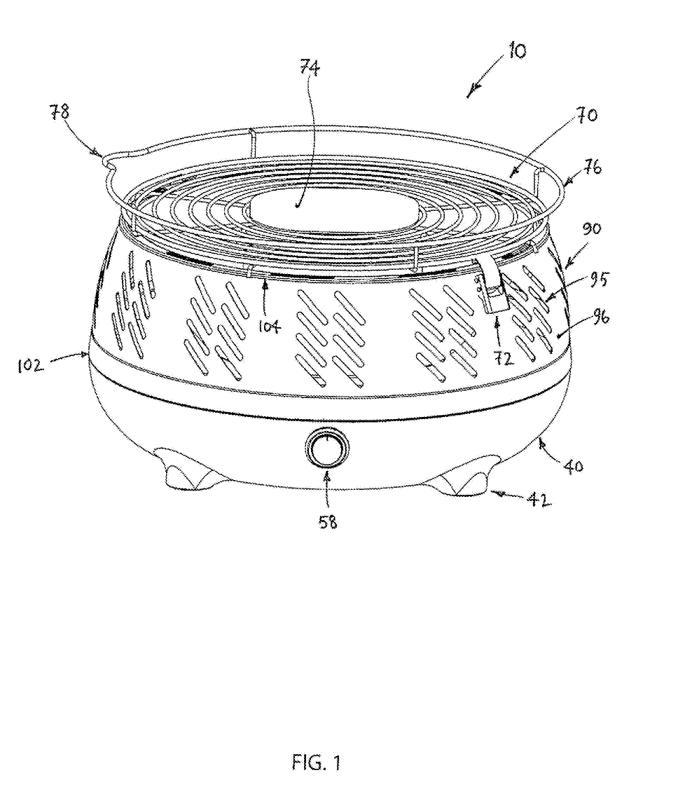

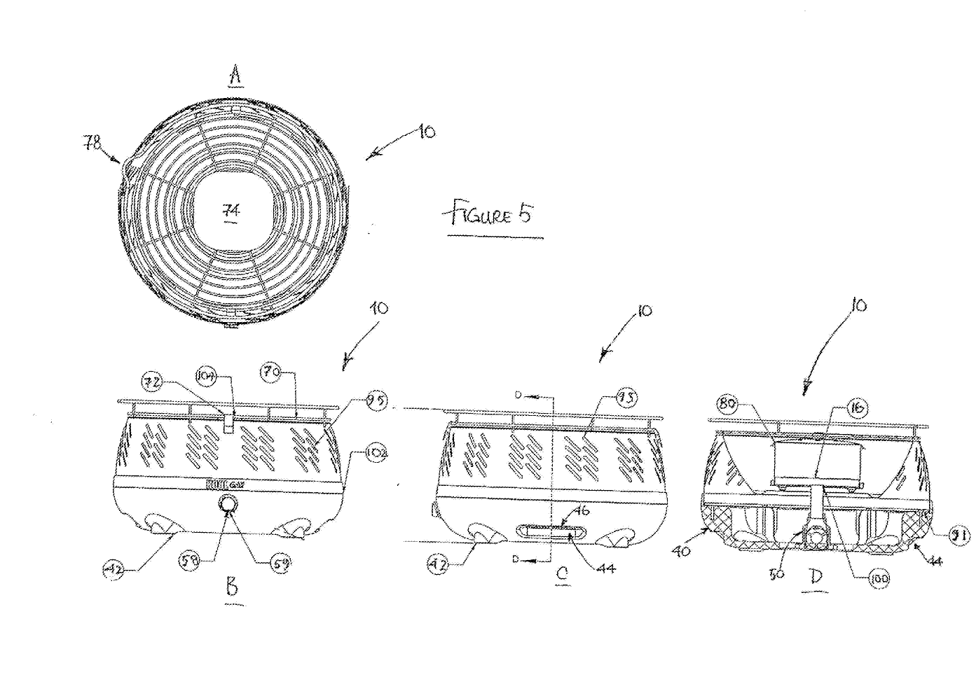

The motor 53 typically incorporates a variable speed controller for varying the rotational speed of the fan 52 (and hence the airflow rate). The controller is operated by a speed control dial 58 (see FIGS. 1, 2, 5B & 6B) which is in turn connected to a potentiometer or similar of the motor 53. The rotation of dial 58 thus changes the motor speed and can be used to control the airflow rate into the ember pot 12. This in turn controls fuel burn and temperature of the barbecue 10. The dial 58 can be LED illuminated 59 (FIG. 6B) to indicate a degree of heat being selected (e.g. blue LED colours for cooler, orange-red LED colours for hotter). The motor 53 can alternatively be a fixed speed motor and simply have an on/off button.

The motor 53 for the fan 52 is battery powered. A battery recess 60 for batteries 62 (e.g. for four AA batteries) is accessible from an underside of the base 40 via a hatch 64 located in the base, to enable battery interchange. The battery recess may hold rechargeable batteries, which can be periodically recharged in situ by a suitable plug-in point (e.g. without needing to access them via hatch 64). In other words, the barbeque 10 can be “plugged-in” for recharging between uses.

The barbecue 10 comprises a grilling surface in the form of a circular grilling grate 70, although the entire surface may take the form of a griddle, plate, etc. In use, the grate 70 is releasably latched to the barbecue 10 via opposing cam-lock catches 72 located at an uppermost part (housing upper rim) of the barbecue 10. The grate 70 comprises a hot plate 74 arranged centrally therewithin. The hot plate allows for the frying of food on the grate 70, and also helps to support e.g. containers and like implements placed on the grate 70 in use. The hot plate 74 is also configured and located to generally overlie the ember pot 12 (see FIGS. 3 & 4) for the receipt of and direct on-transmission of heat/radiation from the ember pot 12. Further, when the cam-lock catches 72 are locked, the hot plate 74 can bear down on and secure a lid 80 to the ember pot 12 (described in more detail below).

The grate 70 also comprises a retention rail 76 that is connected to the grate to extend around a perimeter thereof, at an elevated location. The rail helps to retain food, containers, implements, etc in use of the barbecue 10. The rail 76 further comprises a deformation in the form of an outward protrusion 78 formed therein to enable a suitable barbecue tool to be supported thereat (i.e. to be located at the deformation to hang therefrom).

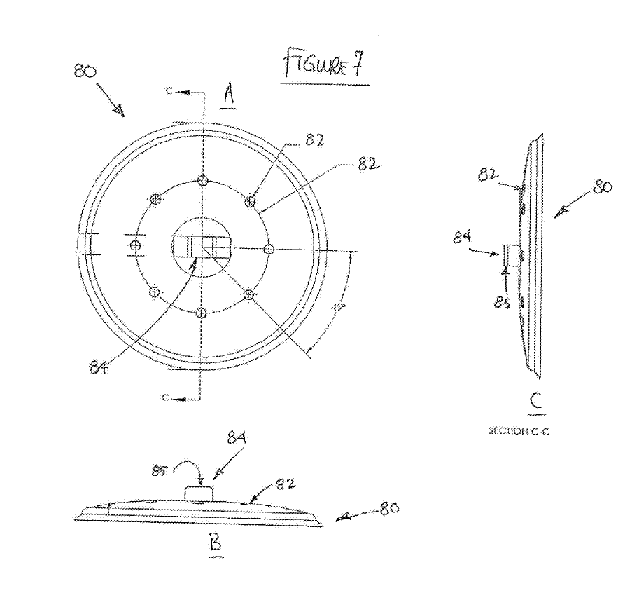

The ember pot 12 also comprises a top in the form of lid 80 (shown in detail in FIG. 7). The lid 80 closes over an in-use upper opening of the mesh wall 13 (see FIGS. 3, 4 & 5D) to retain the fuel as well as embers, ashes, sparks and flames therein. The lid 80 comprises multiple apertures therethrough in the form of a series of spaced, discrete holes 82 that enable the release of heat, hot gases and radiation from within the ember pot 12 in use to the underside of the hot plate 74 (in the direction of arrows E, which are parallel to arrows B). Thus, in the barbecue 10, the general direction of hot gas and heat flow is up towards grate 70.

The lid 80 also comprises an upwardly protruding handle 84 located centrally thereat. When the barbecue 10 is assembled (cam-lock catches 72 are locked), the underside of the hot plate 74 is caused to engage with the handle 84 (i.e. to sit flush with and bear against a flat 85 thereof) to hold the lid 80 against the mesh wall 13, which in turn presses the ember pot 12 against the ignition base tray 22, and thence against the reflector bowl platform 34. This arrangement contains therein the fuel and its residues, and generally holds together the internal components within a housing 90. Thus, the barbeque 10 can be “closed” so as to be self-contained and thereby be rendered highly portable and robust. However, release of the catches 72 allows the grate 70 to be lifted away, and hence the lid 80 to be lifted off, for removal of the ember pot 12, etc for emptying, cleaning, servicing, fuel and lighter replacement, etc.

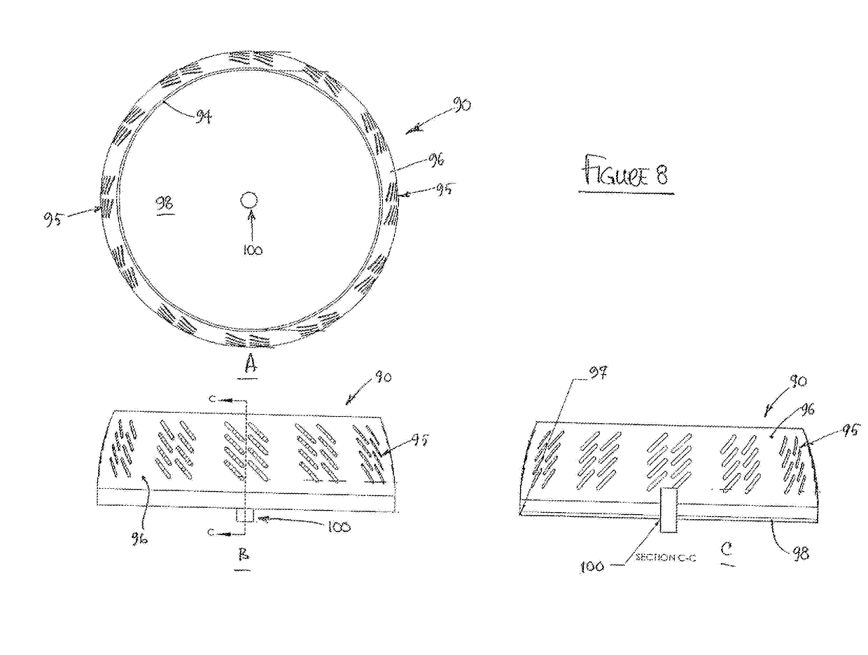

The barbecue 10 also comprises hollow housing 90 (shown in detail in FIG. 8), which has a lower circumferential edge that is mounted at an open upper end (rim 102) of the barbecue base 40. The lower circumferential edge of the housing 90 is seam welded at 97 to a base cover plate 98 which is in turn mounted to the base 40 via releasable, hidden fasteners 91 (e.g. four respective screws—see FIG. 4). Each fastener 91 is fastened into a respective threaded aperture 93 located in an inwardly protruding peripheral ridge 92 formed to extend inwardly of the upper rim 102 of the base 40 (see e.g. FIGS. 4 & 6A).

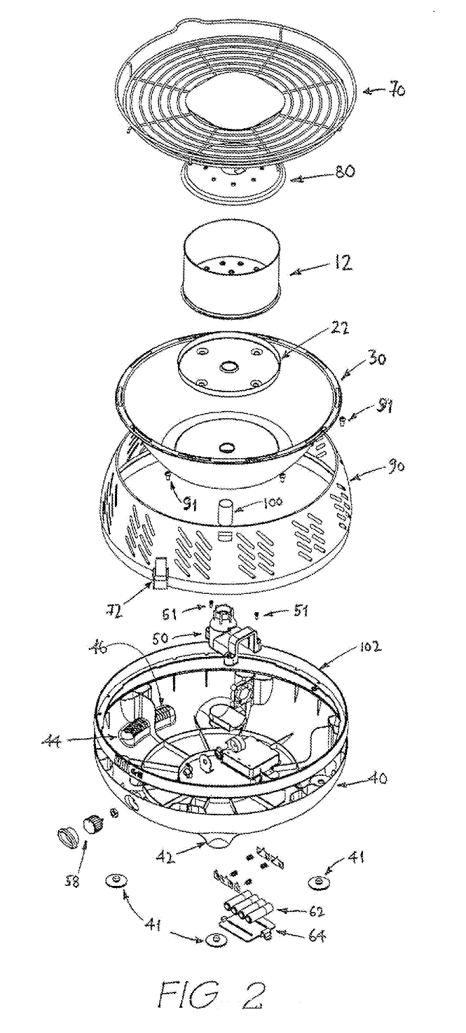

The cam-lock catches 72 are located at an in-use upper rim 93 of the housing 90 (see FIG. 2). Rim 93 also has a flat, inwardly projecting peripheral lip 94 defined thereat. Multiple series of hot air release slots 95 are arranged in and formed through a side wall 96 of the housing 90. The air release slots 95 allow air that is heated adjacent to the underside of the reflector bowl 30 to pass out of the barbecue to atmosphere, to help prevent barbecue overheating. However, when carrying the barbecue 10, it is preferable to employ the recessed handles 44 (i.e. that have the air inlet slots 46 therein), because the handles 44 remain cool to the touch in use of the barbecue 10.

The base cover plate 98 closes off the lower opening of the housing as well as the base upper opening once screw mounted thereto. The base cover plate 98 supports the air supply conduit 100 centrally therewithin. When the base cover plate 98 is screw mounted to the base 40, a lower end of the conduit 100 aligns with the air outlet passage 56 of chamber 50. Also, when the base cover plate 98 is screw mounted to the base 40, and once the barbecue 10 is assembled, the air supply conduit 100 upper end is able to align with and extend through the central rimmed opening 26 defined in the ignition base tray 22, to thereby provide the flow of pressurised air into the plenum space 28.

Further, when the housing 90 is mounted to the barbecue base 40, it can retain a circumferential, circular decorative trim piece 102 (see e.g. FIGS. 2 and 4) between it and the base 40. The trim piece 102 can carry suitable branding, labelling, etc, and can provide an aesthetic effect at the join of the housing and barbecue base.

The housing 90 is also configured to mount and support the reflector bowl 30 therewithin, and to then support the grilling grate 70 at the housing upper rim 92. In this regard, when the reflector bowl 30 is located within the housing 90, the reflector bowl lip 38 sits over and is supported thereunder by the housing lip 94 (as best shown in FIGS. 3 & 4). Thereafter, the grilling grate 70 is located over the reflector bowl lip 138 so that an outermost radial strut 104 of the grate 70 extends over the lip 38. Strut 104 is then able to be secured with respect to the lip 38 by the releasable cam-lock catches 72, thereby securing the grate 70 to the housing 90 (and in turn locking together the internal components 80, 12/13, 22, 30). The locking together of the internal components is sufficiently robust such that the barbecue 10 can be moved about, bumped and knocked during use, again enhancing its portability and ease of use.

In use, the cam-lock catches 72 are released, the grate 70 is removed, and the ember pot 12 is lifted out. The ember pot 12 is filled with fuel and, optionally, a fire-starter (e.g. paraffin, etc) is lit therewithin. Alternatively, a fire-starter (e.g. an ignition-type material such as paraffin, etc) may be lit at the ignition plate 22. The lid 80 is then fitted to close the ember pot 12. The fan 52 is started, and the closed ember pot 12 is then located back within the reflector bowl 30 at the ignition base 22. The grilling grate 70 is then re-secured to the housing 90 via the catches 72. The barbecue 10 is now ready to be used.

After use, and after the barbecue 10 has cooled sufficiently, the above procedure can be reversed to enable cleaning of various internal components as well as servicing of the barbecue, to render it ready for reuse.

Whilst specific embodiments of the barbecue 10 have been described, it should be appreciated that the barbecue may be embodied in other forms.

For example, the air motive mechanism for supplying air to the fuel chamber 12 may, instead of a fan, take the form of an impeller or pump. Also, whilst usually the air motive mechanism is located within the barbeque 10, so that the barbeque 10 can be a self-contained unit, it may take the form of an externally located air pumping mechanism.

In addition, the grilling surface is shown as a grate, but may take the form of a grill, griddle, plate, etc.

In a further, though less desirable variation, the base cover plate 98 can be provided with airflow slots or apertures therein. This can allow atmospheric air to be drawn into the barbecue via the slots 95 defined in the housing side wall 96. As the air is drawn into the housing 90, it is caused to flow past an underside surface of the reflector bowl 30. This can pre-heat the air before it is drawn through the airflow slots or apertures in the base cover plate 98 and into the base hollow interior 43. This preheated air can then be drawn from the base hollow interior 43 by the fan 52, flowing through chamber 50, conduit 100, air plenum 29=8, and into the ember pot 12.

Whilst the preheated air may reduce fuel consumption and/or improve the efficiency of burning of the fuel, to thereby increase the overall efficiency of the barbeque 10, it has been observed that very careful control of the fan speed is required to prevent barbecue overheating. However, if the preheated air is blended with e.g. cooler air flowing in from air inlet slots 46, it can mean that the barbeque 10 may be able to grill for a longer period and/or may operate at lower air inflow (e.g. at a lower fan or pump speed).

In the claims which follow and in the preceding description, except where the context requires otherwise due to express language or necessary implication, the word “comprise” or variations such as “comprises” or “comprising” is used in an inclusive sense, i.e., to specify the presence of the stated features but not to preclude the presence or addition of further features in various embodiments of the grilling apparatus.

1. A grilling apparatus comprising:
a base comprising one or more handles recessed into the base, at least one of the handles comprising therein one or more air inlets to allow air to flow into the base;
a grilling surface that in use of the apparatus is located above the base;
a heat source that in use of the apparatus is located above the base and under the grilling surface; and
an air motive mechanism for causing air to pass through the one or more air inlets and then to the heat source.

2. Apparatus according to claim 1, wherein the base comprises at least two opposing handles recessed thereinto, with each one of the handles comprising multiple air inlets provided therein to allow air to flow into the base from multiple entry points.

3. Apparatus according to claim 1 or 2, wherein the air motive mechanism is located within a chamber that is in turn located within the base, the chamber comprising:
an air entrance arranged to allow air to pass from within the base and into the chamber; and
an air outlet arranged to allow air to pass from the chamber to the heat source;
whereby air that passes through the one or more air inlets is drawn by the air motive mechanism from within base via the air entrance and into the chamber, and is then expelled by the air motive mechanism via the air outlet to the heat source.

4. Apparatus according to claim 3, wherein the air motive mechanism is configured such that the air is drawn into the air entrance in a first direction, and is expelled into the air outlet to the heat source in a second direction that is generally perpendicular to the first direction.

5. Apparatus according to any one of the preceding claims, wherein the heat source comprises a container arranged to contain therein a fuel, the container comprising a side wall for location within the apparatus; a container base for receiving thereat the side wall, the container base further arranged to receive therethrough the flow of air from the air motive mechanism; and a lid for closing over an in-use upper opening of the container;
wherein the lid comprises multiple apertures therein to enable the release of heat from within the heat source in use.

6. Apparatus according to claim 5, further comprising an air supply conduit arranged to supply air from an outlet of the air motive mechanism to the container, the air supply conduit extending through an opening of the container base.

7. Apparatus according to claim 5 or 6, wherein the side wall comprises a cylinder of mesh that is configured to contain therein a solid fuel and its residue in lump, granular or particulate form, but to allow heated air to pass therethrough, and wherein the cylinder of mesh is able to be removably located at the container base.

8. Apparatus according to any one of claims 5 to 7, wherein a perforated or apertured false base is arranged at the side wall and within the container, the false base being in spaced relation above the container base and such that the fuel is able to be located on the false base in use.

9. Apparatus according to any one of the preceding claims, further comprising a reflector that surrounds and supports the heat source therewithin.

10. Apparatus according to claim 9, wherein the reflector comprises a bowl that is configured such that a base of the heat source sits centrally therewithin in use, and wherein the reflector bowl further comprises an annular depression that defines a well that surrounds the central part of the bowl, with a side wall of the reflector bowl extending from the well up towards the grilling surface.

11. Apparatus according to any one of the preceding claims, further comprising a housing for mounting on the base in use, with a housing floor arranged to close an open upper end of the base when mounted thereto.

12. Apparatus according to claim 11, wherein the housing is configured to support the grilling surface at an in-use upper end thereof, the housing further arranged to support the heat source and, when present, the reflector therewithin and under the grilling surface in use.

13. Apparatus according to claim 11 or 12, wherein a side wall of the housing comprises apertures therein to release hot air from within the housing.

14. Apparatus according to any one of the preceding claims, wherein the grilling surface comprises a grate that is able to be removably secured to the apparatus.

15. Apparatus according to claim 14, wherein the grate comprises a plate arranged centrally therewithin, and configured to generally overlie the heat source.

16. Apparatus according to claim 3 or 4, wherein the air motive mechanism comprises a fan, and wherein a motor for the fan is of variable speed such that the flow of air fed to the heat source can be varied.

17. A grilling apparatus comprising:
a base;
a grilling surface that in use of the apparatus is located above the base;
a heat source that in use of the apparatus is located above the base and under the grilling surface;
a container arranged to contain therein a fuel; and
a lid for closing over an in-use upper opening of the container, wherein the lid comprises multiple apertures therein to enable the release of heat and hot gases from within the container in use.

18. Apparatus according to claim 17, the apparatus being otherwise as defined in any one of claims 1 to 16.

19. A grilling apparatus comprising:
a heat source that is located in the apparatus;
a grilling surface;
a reflector bowl that surrounds and supports, at a central part within the reflector bowl, the heat source, so as to reflect heat and radiation emitted by the heat source to the grilling surface, the reflector bowl further comprising an annular depression that defines a well that surrounds the central part.

20. Apparatus according to claim 19, wherein a side wall of the reflector bowl has an internal reflective surface that extends from the well up towards the grilling surface, the reflective surface also able to redirect hot combustion gases towards the grilling surface.

21. Apparatus according to claim 19 or 20, wherein the central part defines a platform that is raised with respect to the well, the platform defining a mounting location for the heat source.

22. Apparatus according to claim 21, wherein the well connects the side wall and platform and is able to hold a liquid that can vaporize or a solid that can sublimate during operation of the grilling apparatus.

23. A grilling apparatus comprising:
a heat source that is located in the apparatus;
a grilling surface;
a reflector bowl that surrounds and supports the heat source at a central part therewithin so as to reflect heat emitted by the heat source to the grilling surface, with the central part defining a platform for the heat source, whereby a combustible fuel is able to be spaced above the platform and contained within the heat source.

24. Apparatus according to claim 23, the apparatus being otherwise as defined in any one of claims 1 to 22.

25. A grilling apparatus comprising:
a grilling surface;
a heat source that in use is located within the apparatus under the grilling surface, with a side wall of the heat source being able to radiate and release heat and heated gases in a first direction; and
an air motive mechanism for supplying air to the heat source in a second direction;
wherein the second direction is generally perpendicular to the first direction.

26. A grilling apparatus as claimed in claim 25, further comprising a reflector which is arranged with respect to the heat source, the reflector able to reflect radiation, heat and heated gases emitted by the heat source to the grilling surface in a third direction that is generally perpendicular to the first direction and that is generally parallel to the second direction.

27. A grilling apparatus as claimed in claim 26, wherein the heat source further comprises a top that is able to radiate and release heat and/or heated gases to the grilling surface in the third direction.

28. A grilling apparatus as claimed in any one of claims 25 to 27, wherein the air motive mechanism causes air to pass through one or more inlets in the grilling apparatus and then to the heat source in a fourth direction, wherein the fourth direction is parallel to the first direction.

29. Apparatus according to any one of claims 25 to 28, wherein a central part of the reflector defines a platform for the heat source, whereby a combustible fuel is able to be arranged above the platform and contained within the heat source, and wherein an air supply conduit is arranged to supply the air through an opening of the platform in the second direction.

30. Apparatus according to any one of claims 25 to 29, the apparatus being otherwise as defined in any one of claims 1 to 24.
